(19) United States
(12) Patent Application Publication
(10) Pub. No.: US 2025/0043457 A1
(43) Pub. Date: Feb. 6, 2025

(54) TREATMENT SYSTEM AND METHOD FOR TREATING WORKPIECES

(71) Applicant: DÜRR SYSTEMS AG, Bietigheim-Bissingen (DE)

(72) Inventors: Tobias JÄGER, Karlsruhe (DE); Dietmar WIELAND, Waiblingen (DE); Marek DOWNAR, Ditzingen (DE); Oliver SEYBOTH, Hemmingen (DE); Michael LAUER, Bietigheim-Bissingen (DE)

(21) Appl. No.: 18/720,406

(22) PCT Filed: Dec. 13, 2022
(86) PCT No.: PCT/DE2022/100950

§ 371 Date: Jun. 14, 2024

(30) Foreign Application Priority Data
Dec. 21, 2021 (DE) 10 2021 214 826.3

(51) Int. Cl. C25D 13/12; B05B 13/02

(52) U.S. Cl. CPC C25D 13/12; B05B 13/0221

(57) ABSTRACT

In order to provide a treatment system which has a simple design and can be easily expanded and efficiently operated, the treatment system according to the invention comprises a plurality of fluid tanks, a conveying system, and a fluid connecting device for establishing a fluid connection between a plurality of fluid tanks.

### RELATED APPLICATIONS

This application is a national phase of international application No. PCT/DE2022/100950 filed on Dec. 13, 2022, and claims the benefit of German application No. 10 2021 214 826.3 filed on Dec. 21, 2021, which are incorporated herein by reference in their entirety and for all purposes.

### FIELD OF DISCLOSURE

The present disclosure relates to a treatment system for treating workpieces—in particular, vehicle bodies. The treatment system serves in particular for coating, e.g., painting, vehicle bodies in the production of motor vehicles—in particular, passenger cars.

### BACKGROUND

For example, a dip coating process can be carried out for coating vehicle bodies. For this purpose, the vehicle bodies are conveyed through a fluid tank in particular in a conveying direction. Fluid tanks extending in the conveying direction are usually provided and can simultaneously receive a plurality of vehicle bodies.

### SUMMARY

The object of examples disclosed herein is that of providing a treatment system which has a simple structure and is extendable, and also can be operated efficiently. In particular, the treatment system according to examples disclosed herein should enable a greater flexibility in the workpiece treatment.

The object of examples disclosed herein is achieved by a treatment system according to claim 1.

The treatment system serves to treat workpieces—in particular, vehicle bodies—and comprises in particular the following:
a plurality of fluid tanks which are fillable or filled with a treatment fluid and into which the workpieces can be introduced for carrying out a treatment process;
a conveying system for supplying the workpieces to the fluid tanks and/or for removing the workpieces from the fluid tanks;
a fluid connection device for establishing a fluid connection between a plurality of fluid tanks.

The conveying system serves in particular to convey the workpieces above the fluid tanks.

The workpieces are preferably introduced into the fluid tanks from above.

For example, the conveying system can comprise a main conveying device by means of which the workpieces can be conveyed in a main conveying direction. One or more of the fluid tanks are preferably arranged laterally offset next to the main conveying device.

The conveying system preferably comprises one or more transverse conveying devices by means of which the workpieces can optionally be supplied to the individual fluid tanks.

It can be favorable if a fluid connection is established between a plurality of functionally identical fluid tanks, in which in particular identical treatment processes are carried out, and/or between a plurality of fluid tanks filled with a chemically identical treatment fluid.

It can be favorable if a plurality of the fluid tanks are self-contained individual containers for receiving the treatment fluid and in each case a single workpiece.

An individual container preferably has less than approximately twice the length and/or twice the width of a workpiece to be treated therein.

A fluid tank designed as an individual container is in particular designed to be free-standing and has a bottom wall and four side walls which surround an interior of the individual container. In particular, containers which form a plurality of fluid tanks are to be distinguished from this.

Alternatively or in addition to a plurality of fluid tanks designed as individual containers, a plurality of fluid tanks can be provided which are adjacent portions of a single container for receiving the treatment fluid. A single workpiece can preferably be received in each of these fluid tanks. The container which comprises or forms the plurality of fluid tanks preferably makes it possible to receive a plurality of workpieces simultaneously.

However, in such a container, the fluid tanks are preferably designed to be closed off at least in such a way that a workpiece treatment independent of the other fluid tanks can be carried out.

The fluid connection device can comprise one or more overflow units which are connected to a plurality of the fluid tanks in each case and serve to receive treatment fluid which overflows from these fluid tanks.

Such an overflow unit is in particular a weir which is arranged on two side walls of the fluid tanks—in particular, of individual containers which form the fluid tanks—said side walls adjoining one another and/or following one another in the main conveying direction.

Furthermore, one or more overflow units can be arranged between two fluid tanks in each case.

The fluid connection device preferably comprises one or more flow devices by means of which a treatment fluid can be supplied from one of the fluid tanks to another of the fluid tanks.

The one or more flow devices in particular each comprise one or more pump devices and/or one or more nozzle devices—for example, one or more nozzle fittings.

Alternatively or in addition to one or more flow devices, the treatment system—in particular, one or more fluid tanks—in each case can comprise one or more mixing devices for mixing treatment fluid, already present in the corresponding fluid tank, with supplied treatment fluid.

For example, the fluid connection device can comprise or form a circulating device for circulating the treatment fluid between a plurality of fluid tanks.

The one or more mixing devices then serve, in particular, to ensure a treatment fluid composition and/or treatment fluid quality that is as uniform and/or homogeneous as possible in the fluid tanks which are connected to one another by means of the fluid connection device.

One or more mixing devices preferably each comprise one or more nozzle devices—in particular, one or more nozzle fittings.

The fluid connection device can comprise one or more pipe elements for establishing a fluid connection between two or more of the fluid tanks.

In particular one or more pump devices are arranged on and/or integrated into the one or more pipe elements. On the one hand, circulation of treatment fluid between two or more than two fluid tanks can thereby be made possible. On the other hand, a fill-level variation and/or check can thereby preferably be made possible.

It can be advantageous if a plurality of the fluid tanks adjoin one another directly and if side walls, facing one another, of the fluid tanks are formed by a common container wall or a common partition wall.

The partition wall is in particular a partition wall between two treatment regions.

It can be favorable if the container wall or the partition wall comprises one or more passage openings, so that a fluid connection is formed between the fluid tanks. The one or more passage openings preferably form the fluid connection device or are a component thereof.

The one or more passage openings can be closable—for example, be automatically closable and/or releasable.

Furthermore, the container wall or the partition wall can be porous and/or be provided with slots or other openings and thus be fluid-permeable. Furthermore, alternatively or additionally, the container wall or the partition wall can have a reduced overall height, so that in particular the treatment fluid can flow above or below the container wall or the partition wall from one fluid tank into the adjacent fluid tank.

It can be favorable if the container wall or the partition wall is designed at least in portions as a grid—for example, as a wire grid. The treatment fluid can thereby in particular circulate between the fluid tanks at least approximately freely.

Uniform mixing can preferably be achieved by means of one or more mixing devices—for example, nozzle devices.

It can be advantageous if the container wall or the partition wall is designed to be movable
in particular, liftable and/or lowerable—at least in portions or completely.

The container wall or the partition wall can in particular be discharged from or introduced into the container in at least an approximately vertical direction.

For example, the container wall or the partition wall can be flexibly mounted—in particular, in order to enable simple adaptation of the fluid tank size to workpiece types of different dimensions.

In each case one or more electrodes for generating an electric field can be arranged in two or more than two fluid tanks which are connected to one another by means of the fluid connection device. The electrical fields generated in the fluid tanks are preferably decoupled from one another and/or shielded from one another.

In particular, the electrical fields in the individual fluid tanks can preferably be decoupled from one another and/or shielded from one another in such a way that treatment processes which are completely independent of one another can be carried out in the individual fluid tanks—in particular, without impairment of a treatment result due to treatment processes taking place adjacent to one another.

A common container wall of two containers which each form a fluid tank and/or treatment regions of a container which form a partition wall between two fluid tanks is preferably designed to be electromagnetically shielding.

A partition wall of the treatment system which separates two treatment regions of a container which form two fluid tanks from one another can
a) be designed as a grid or mesh, and/or
b) comprise an additional support structure; and/or
c) receive one or more electrodes.

One or more electrodes can be arranged directly on the partition wall of the treatment system.

Furthermore, one or more electrodes can be arranged and/or received on an additional support structure of a partition wall of the treatment system.

It can be favorable if the partition wall is designed as an electromagnetically shielding grid or mesh.

In particular, the grid is a metal grid.

Openings or through-openings in the partition wall are preferably selected to be small enough for electromagnetic shielding.

For optimized electromagnetic shielding, coupling points—in particular, openings, slots, pipe connections, etc.—can preferably be provided with additional deflections and/or labyrinth-like configurations—for example, baffles and/or angles. Alternatively or additionally, a shielding effect can be optimized by suitable material choice.

In particular when the electrodes are anodes, flat and or half-round anodes can be arranged on the partition wall, wherein the anodes of opposite sides of the partition wall preferably are mounted such that the anodes face one another with their corresponding rear side. In particular, a plurality of electrodes, e.g., anodes, can have a common housing and/or common connections.

An additional support structure can, for example, be mounted and/or fixed on a tank edge of a fluid tank and/or can span the fluid tank or a region between two fluid tanks. In particular, the additional support structure can be mounted and/or fixed by means of guide rails and/or bearing points at the edge of a container, which in particular forms or encompasses a plurality of fluid tanks. In particular, the assembly can take place at the edge of the container on its inner side and/or outer side and on its upper side.

The additional support structure be of modular design, wherein—in particular, for assembly thereof—further components can be pre-assembled in a container, e.g., electrodes—in particular, anodes.

It can be advantageous if the additional support structure has one or more plug connections.

A plug connection can in particular be arranged and/or formed in a bottom region—in particular, on a container bottom.

As an alternative or in addition to a plug connection, shafts and/or profiles can in particular be provided for assembly.

By suitable design of the additional support structure and/or attachment points of the additional support structure, e.g., by suitable design of the plug connection and/or by suitable design of shafts and/or profile elements, a rotation or other movement of the additional support structure can preferably be avoided. In particular, a form-fit fixing can be enabled with simultaneously correct rotational alignment.

In particular, when electrodes designed as anodes are mounted with the rear sides facing one another, guide rails for mounting the electrodes can be taken into account by a correspondingly complementary recess between the fluid tanks and/or electrodes.

In particular when the additional support structure comprises profiles designed as hollow profiles, one or more hollow profiles can serve for media supply and/or media discharge for the electrodes—in particular, anodes. Alternatively or additionally, one or more hollow profiles can be part of the fluid connection device and serve to supply and/or discharge treatment fluid into or out of the respective fluid tank.

It can be advantageous if a fluid tank—in particular, a container or individual container—is a molded component—for example, formed from a shape-adapted component. In one or more side walls, in particular a recess or a rebate can then be provided which is designed to be at least approximately complementary to a shape of an electrode to be arranged thereon.

For installation and maintenance of fittings in one or more of the fluid tanks, the conveying system can be used in order to be able to deliver components to be mounted and/or to be serviced from the one or more fluid tanks or to be able to introduce them into same. For this purpose, the components are preferably provided with engagement elements, e.g., eyelets, holders, or other fastening elements, in order to enable a simple connection to a conveying device of the conveying system. For example, a separate, replaceable adapter of a conveying device of the conveying system can be provided in order to be able to carry out assembly and/or maintenance of components of the treatment system, if necessary, instead of the workpiece transport.

A plurality of the fluid tanks can be arranged next to one another in the horizontal direction.

Alternatively or additionally, a plurality of the fluid tanks can be arranged one above the other in the vertical direction.

It can be advantageous if a plurality of the fluid tanks are arranged at different height levels and are positioned directly above one another or laterally offset relative to one another.

A fluid connection is preferably also produced or producible between such fluid tanks by means of the fluid connection device.

A plurality of fluid tanks can be arranged offset relative to one another in the vertical direction and a fluid connection between these fluid tanks can be produced by means of the fluid connection device in such a way that treatment fluid of a fluid tank which is higher in the vertical direction flows automatically into a fluid tank which is lower in the vertical direction.

The terms “higher” and “lower” refer, as relative terms, to the positioning of the interconnected fluid tanks relative to one another.

By supplying the treatment fluid from the fluid tank higher in the vertical direction into the fluid tank lower in the vertical direction, a flow can preferably be generated in the fluid tank which is lower in the vertical direction and/or mixing of the treatment fluid in the fluid tank which is lower in the vertical direction can be optimized.

It may be advantageous if the treatment system comprises a preparation device for preparing the treatment fluid.

The preparation device is in particular arranged in a return path of the fluid connection device.

In particular, the return path connects the fluid tank which is lower in the vertical direction to the fluid tank which is higher in the vertical direction and serves to return the treatment fluid from the fluid tank which is lower in the vertical direction into the fluid tank which is higher in the vertical direction.

If fluid tanks are arranged at the same height level, the return path, which can also be provided in such embodiments, serves in particular to return the treatment fluid from an overflow unit back into the interconnected fluid tanks.

In particular, when fluid tanks are connected to one another by means of the fluid connection device, which fluid tanks are at different height levels, a sensor device for monitoring a fill level of the fluid tank which is lower in the vertical direction and/or of the fluid tank which is higher in vertical direction is preferably provided. In particular, it can preferably be determined and/or avoided by means of the sensor device that too much treatment fluid flows into the fluid tank lower in the vertical direction—in particular, in order to prevent overflow of the fluid tank.

For this purpose, in particular valves and/or flaps in the fluid lines connecting the two tanks to one another can be actuated and/or controlled by means of the sensor device.

Furthermore, one or more pump devices and/or bypass devices can preferably be actuated and/or controlled by means of the sensor device—in particular, in order to avoid damage or other malfunction of the treatment system when fill levels are outside specified value ranges.

The treatment system thus comprises in particular a sensor device by means of which a filling height of the fluid tank which is lower in the vertical direction can be determined and by means of which, when a predetermined maximum filling height is exceeded, a further supply of treatment fluid into this fluid tank can be stopped.

By means of the fluid connection of two or more than two fluid tanks, a scalability and/or a modular construction of the treatment system can preferably be enabled and/or optimized.

In particular, by connecting or supplementing further fluid tanks, an existing infrastructure of further tanks for this additional fluid tank can be used. By means of the fluid connection device, a constant treatment quality can be ensured by uniform distribution and/or preparation of the treatment fluid.

Furthermore, in the case of a reduced production requirement, a partial shutdown can easily be made possible by the fact that individual fluid tanks—in particular, individual containers—are decoupled from a fluid connection device and thus from further fluid tanks. Unused system areas can thus be shut down in particular in an energy-saving and cost-saving manner.

In particular, a cathodic dip coating can be carried out in the fluid tank.

The fluid tanks are preferably accessible exclusively from above. In particular, the fluid tanks form dip tanks.

The treatment system is thus in particular a dip coating system—in particular, a system for cathodic dip coating.

Examples disclosed herein furthermore relate to a method for treating workpieces—in particular, vehicle bodies.

In this respect, the problem addressed by examples disclosed herein is that of providing a method by means of which a workpiece treatment can be carried out efficiently given varying production capacities and/or varying workpiece requirements. According to examples disclosed herein, this object is achieved by a method according to the independent method claim.

The method is in particular a method for treating workpieces—in particular, vehicle bodies.

In the method, in particular treatment fluid is supplied to a plurality of fluid tanks of a treatment system—in particular, of the treatment system according to examples disclosed herein. The treatment fluid is preferably supplied here in succession to the plurality of fluid tanks and/or circulated between the plurality of fluid tanks.

The method according to examples disclosed herein preferably has one or more of the features and/or advantages described in conjunction with the treatment system according to examples disclosed herein.

Furthermore, the treatment system according to examples disclosed herein can have one or more of the features and/or advantages described in conjunction with the method according to examples disclosed herein.

Further preferred features and/or advantages of examples disclosed herein form the subject matter of the following description and the drawings illustrating exemplary embodiments.

### BRIEF DESCRIPTION OF THE DRAWINGS

FIG. 1 is a schematic plan view of an embodiment of a treatment system for carrying out dip coating processes, wherein the treatment system has a main conveying device and treatment containers which are arranged laterally offset thereto and are designed as dip containers;

FIG. 2 is a schematic plan view of an upper side of two fluid tanks of a treatment system, wherein the fluid tanks are fluidically connected to one another by means of a common overflow unit;

FIG. 3 is a schematic representation corresponding to FIG. 2 of an alternative embodiment of a fluid connection device for connecting two fluid tanks, wherein two flow devices for connecting the fluid tanks are provided in addition to a common overflow unit;

FIG. 4 is a schematic representation corresponding to FIG. 2 of a further alternative embodiment of a treatment system in which two fluid tanks separated from one another with a fluid-permeable partition wall are provided;

FIG. 5 is a schematic perspective representation of an alternative embodiment of a partition wall for separating two fluid tanks from one another;

FIG. 6 is a schematic perspective representation corresponding to FIG. 5 of an alternative embodiment of a partition wall for separating two fluid tanks from one another;

FIG. 7 is a schematic side view of an alternative embodiment of a treatment system in which fluid tanks arranged directly one above the other in the vertical direction are provided; and

FIG. 8 is a schematic side view corresponding to FIG. 7 of a further alternative embodiment of a treatment system, in which fluid tanks are provided laterally offset and arranged at different height levels.

The same or functionally equivalent elements are provided with the same reference signs in all figures.

### DETAILED DESCRIPTION

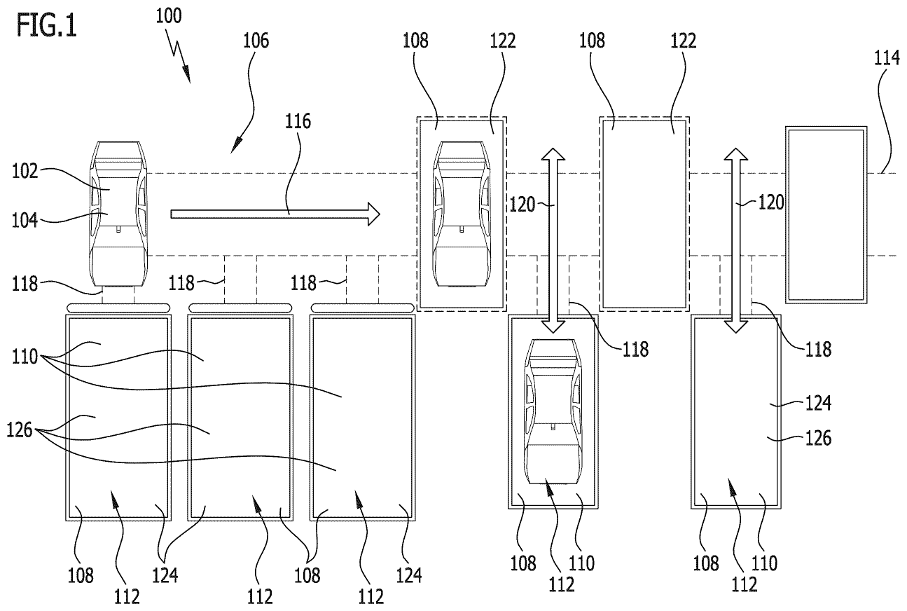

A treatment system shown in FIG. 1 and denoted as a whole by 100 serves to treat workpieces 102—for example, vehicle bodies 104.

The treatment system 100 comprises a conveying system 106 by means of which the workpieces 102 can be brought into different treatment positions.

The treatment positions are in particular arranged at treatment stations 108 of the treatment system 100.

The treatment system 100 comprises a plurality of treatment containers 110 in which the workpieces 102 can be immersed.

The treatment containers 110 are in particular dip stations 112 for carrying out a dip coating process—in particular, for cathodic dip coating of the workpieces 102.

The conveying system 106 comprises a main conveying device 114, by means of which the workpieces 102 can be conveyed in particular in a transverse orientation thereof in a main conveying direction 116.

Furthermore, the conveying system 106 preferably comprises one or more transverse conveying devices 118, by means of which the workpieces 102 can be moved transversely—in particular, at least approximately perpendicular—to the main conveying direction 116.

In particular, the workpieces 102 can be supplied to the treatment containers 110 by means of the one or more transverse conveying devices 118.

A conveying direction of the transverse conveying devices 118 is in particular a transverse conveying direction 120 which is oriented in particular at least approximately perpendicularly to the main conveying direction 116.

The treatment system 100 further preferably comprises treatment stations 108 formed as spray stations 122, for example.

As can be seen from FIG. 1, the workpieces 102 can preferably be supplied one after the other to one or more of the dip stations 112 and then one or more of the spray stations 122 in order to carry out a treatment of the workpieces 102.

According to FIG. 1, the dip stations 112 are in particular isolated fluid tanks 124 which are formed in particular by individual containers 126.

The dimension of the fluid tanks 124 is selected such that precisely one workpiece 102 always fits into the corresponding fluid tank 124.

A treatment fluid required in the fluid tank 124 for carrying out treatment processes can, for example, be provided, circulated, and/or prepared in an isolated fashion for each fluid tank 124.

Particularly with regard to optimized use and flexibility of the treatment system 100, however, a fluid guide spanning a plurality of fluid tanks 124 can be provided.

The treatment system 100 therefore preferably comprises a fluid connection device 128 by means of which a plurality of fluid tanks 124 are fluidically connected to one another.

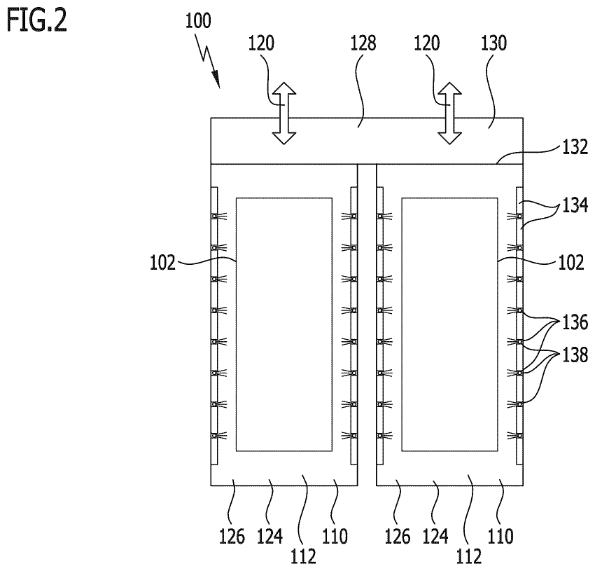

According to FIG. 2, the fluid connection device 128 can comprise an overflow unit 130, which jointly adjoins two adjacent individual containers 126 which each form a fluid tank 124.

The overflow unit 130 is designed, for example, as a weir 132 and serves to receive and merge treatment fluid that flows over from both fluid tanks 124.

In FIG. 2, further components of the fluid connection device 128—in particular, a preparation device for preparing removed treatment fluid, and a return device for returning same into the two fluid tanks 124—are not shown.

The fluid connection device 128 thus enables in particular a common fluid supply of both fluid tanks 124.

In particular, if only a single one of the two fluid tanks 124 is used temporarily—for example, due to reduced production capacities—the fluid connection device 128 together with the preparation device and/or the return device can be further used without impairment in order to supply one of the fluid tanks 124 with treatment fluid. The further of the two fluid tanks 124 can then in particular be shut down, e.g., dry, in order to reduce energy and/or maintenance costs.

Furthermore, further fluid tanks 124 can preferably be added as required by suitable design of the overflow unit 130 and/or the remaining fluid connection device 128 in order to also enable a modular scalability of the treatment system 100 upwards.

As can also be seen from FIG. 2, a plurality of electrodes 134—in particular, anodes—are preferably arranged in the fluid tank 124.

By means of the electrodes 134, in particular an electrical field within the fluid tanks 124 can be generated in order to be able to carry out electrocoating processes—in particular, cathodic dip coating.

The fluid tanks 124 are further preferably provided with one or more mixing devices 136—for example, one or more nozzle devices 138.

By means of the mixing devices 136, in particular uniform mixing of the treatment fluid in the corresponding fluid tank 124 can be ensured in order to enable a homogeneous workpiece treatment.

In the embodiment of the fluid connection device 128 shown in FIG. 2, the fluid connection of the two fluid tanks 124 preferably takes place exclusively via the overflow unit 130.

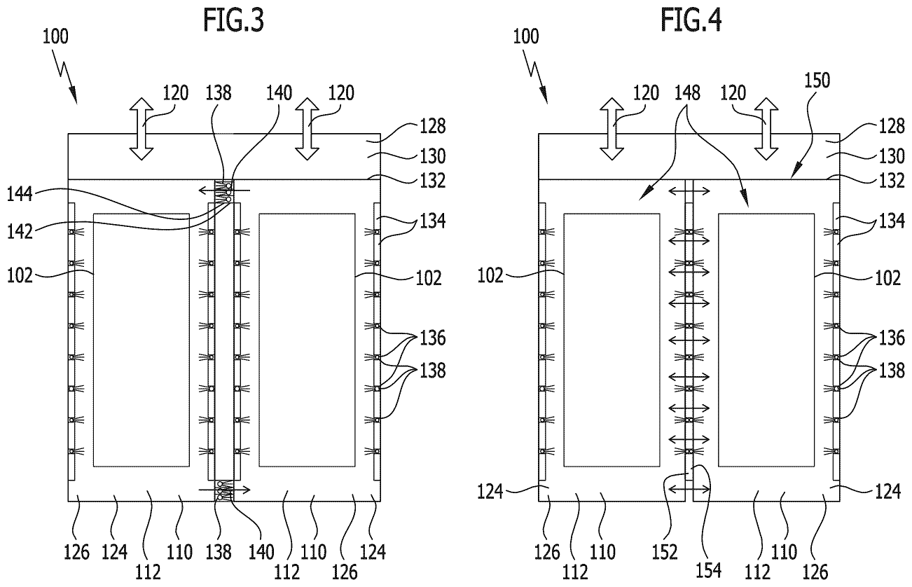

By contrast, an alternative embodiment of the fluid connection device 128 shown in FIG. 3 provides for the additional use of one or more flow devices 140.

The flow devices 140 are formed in particular by one or more pipe elements 142 and/or one or more pump devices 144, or comprise the same. Alternatively or additionally, the one or more flow devices 140 can also comprise one or more nozzle devices 138.

As can be seen from FIG. 3, the one or more flow devices 140 are arranged and/or formed in particular as connecting elements between the fluid tanks 124.

For example, a flow device 140 can be provided for conveying treatment fluid from one of the fluid tanks 124 into the further of the fluid tanks 124, while a further flow device 140 serves to return the treatment medium. In particular, a circulation of the treatment fluid through both fluid tanks 124 can thus be enabled.

Otherwise, the embodiment of the fluid connection device 128 shown in FIG. 3 corresponds in terms of structure and function to the embodiment shown in FIG. 2, such that reference is made to the above description thereof.

A further alternative embodiment of the fluid connection device 128 and/or the fluid tank 124 shown in FIG. 4 differs from the embodiment shown in FIG. 2 substantially in that the fluid tanks 124 are not separated from one another as individual containers 126. Rather, the fluid tanks 124 are portions 148 of a container 150 which surrounds or forms a plurality of fluid tanks 124.

The fluid tanks 124 are separated from one another by means of a partition wall 152, wherein the partition wall 152 forms the side walls 154, facing one another, of the two fluid tanks 124 and at the same time is fluid-permeable in order to enable fluid exchange between the two fluid tanks 124 (indicated by the double arrows in FIG. 4).

In the embodiment of the treatment system 100 shown in FIG. 4, the partition wall 152 thus does not serve for the fluid-effective separation of the fluid tanks 124 from one another. Rather, the partition wall 152 serves for electromagnetic separation of the fluid tanks 124 from one another.

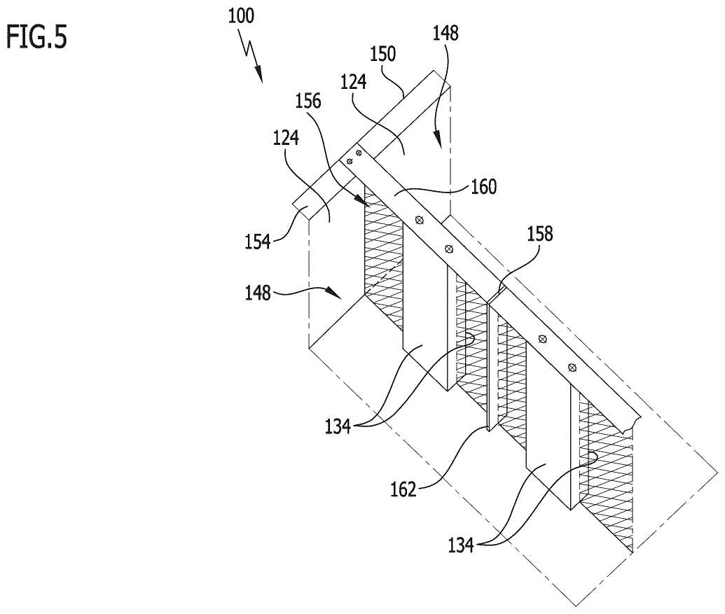

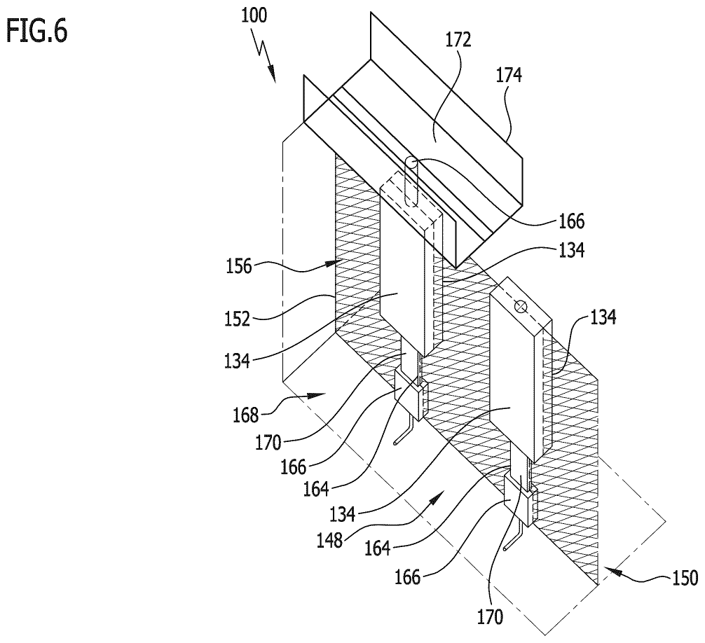

For example, for different variants of the partition wall 152, reference is made to FIGS. 5 and 6.

As can be seen from the two figures, a partition wall 152 can be designed, for example, as a grid 156 or can comprise such a grid.

The partition wall 152 is in particular fixed to a side wall 154 of the container 150 and extends through the container 150 in order to separate the different portions 148 of the container 150 from one another.

The partition wall 152 can be designed to be electrically continuous—in particular, to lie at the same potential. Optionally, the use of one or more separating elements 158 can also be provided for. By means of one or more separating elements 158, the partition wall 152 can in particular be subdivided into different regions or modules. On the one hand, an electromagnetic separation of different parts of the partition wall 152 from one another can thereby take place. Furthermore, a modular design of the partition wall 152 can be realized by means of a separating element 158 for simplified assembly and/or maintenance.

One or more of the electrodes 134 are preferably arranged on the partition wall 152.

The electrodes 134 are fixed here directly to the grid 156, for example (see FIG. 5).

For example, a cross strut 160 resting on a tank edge of the container 150 can preferably carry the electrodes 134 along the direction of gravity.

One or more support elements 162 can optionally be provided to support the partition wall 152.

As can also be seen from FIG. 5, the electrodes 134 can in particular be arranged on both sides of the grid 156. The electrodes 134 are in particular arranged such that they are arranged facing one another with their corresponding rear side.

The field generated by means of the corresponding electrode 134 thus extends in particular starting from the grid 156 into the corresponding fluid tank 124.

Due to the grid 156, which in particular is metal, an electromagnetic shielding preferably results between the fluid tanks 124, so that a treatment of the workpieces in the two fluid tanks 124 can take place completely independently of one another.

An alternative embodiment of a partition wall 152 shown in FIG. 6 can differ from the embodiment shown in FIG. 5 in particular in that an additional support structure 164 is provided which, in particular, comprises one or more plug connections 166 for fixing the electrodes 134—for example, on a container bottom 168 of the container 150.

The support structure 164 can in particular comprise one or more hollow profiles 170, which can in particular be media-carrying. For example, media can be supplied to the electrodes 134—in particular, analyte—by means of one or more hollow profiles 170.

Furthermore, components of the fluid connection device 128 can be formed by means of the hollow profiles 170 of the support structure 164.

The additional support structure 164 can thus in particular also serve to supply and/or remove treatment fluid and/or the uniform distribution thereof to a plurality of fluid tanks 124.

Optionally, an access region 172 of the treatment system 100 can also be formed on the partition wall 152.

The access region 172 is in particular a region accessible to people. The access region 172 preferably comprises on both sides a handrail 174 for protecting the people from falling off the fluid tanks 124.

The electrodes 134 are preferably particularly easily accessible via the access region 172.

Otherwise, the embodiment of the partition wall 152 shown in FIG. 6 corresponds in terms of structure and function to the embodiment shown in FIG. 5, such that reference is made to the above description thereof.

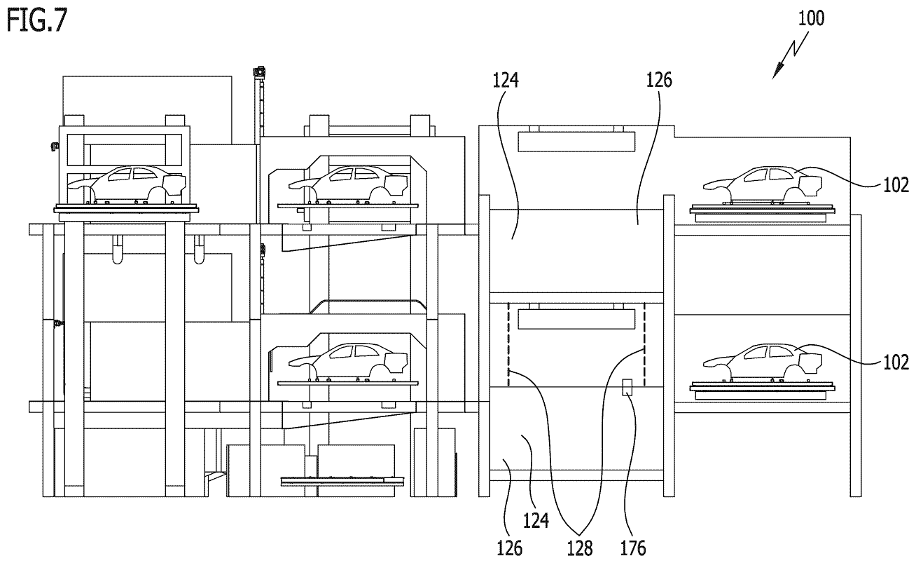

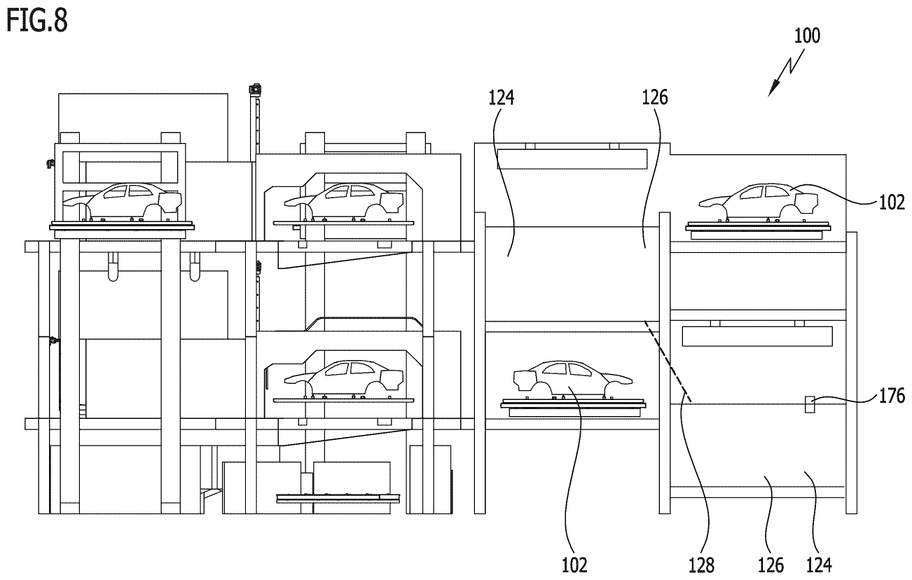

FIGS. 7 and 8 show two different embodiments of treatment systems 100, in which fluid tanks 124—in particular, individual containers 126—are arranged at different height levels.

In this case, the fluid tanks 124 are arranged in particular directly above one another along the direction of gravity (see FIG. 7). By means of the fluid connection device 128, fluid can then in particular be guided from one of the fluid tanks 124 into the other of the fluid tanks 124.

In particular, the treatment fluid can flow from the fluid tank 124 which is higher in the direction of gravity into the fluid tank 124 which is arranged therebelow only under the effect of gravity.

By means of one or more pump devices 144 of the fluid connection device 124, treatment fluid can furthermore be pumped from the fluid tank 124 which is lower in the vertical direction into the fluid tank 124 arranged thereabove.

A sensor device 176 preferably serves to monitor a fill level in one or more of the fluid tanks 124—in particular, in order to avoid an overflow of the fluid tank 124 which is lower in the vertical direction.

As an alternative to the arrangement of the fluid tanks 124 shown in FIG. 7, a laterally offset arrangement of the fluid tanks 124 according to FIG. 8 arranged at different height levels can be provided. In such an embodiment, in particular a better distribution of the surface load and/or a reduced overall height can result. Otherwise, the embodiment of the treatment system 100 shown in FIG. 8 corresponds, in terms of structure and function, to the embodiment shown in FIG. 7, such that reference is made in this respect to the above description thereof.

### LIST OF REFERENCE SIGNS

100 Treatment system
102 Workpiece
104 Vehicle body
106 Conveying system
108 Treatment station
110 Treatment container
112 Dip station
114 Main conveying device
116 Main conveying direction
118 Transverse conveying device
120 Transverse conveying direction
122 Spray station
124 Fluid tank
126 Individual container
128 Fluid connection device
130 Overflow unit
132 Weir
134 Electrode
136 Mixing device
138 Nozzle device
140 Flow device
142 Pipe element
144 Pump device
148 Portion
150 Container
152 Partition wall
154 Side wall
156 Grid
158 Separating element
160 Cross strut
162 Support element
164 Support structure
166 Plug connection
168 Container bottom
170 Hollow profile
172 Access region
174 Handrail
176 Sensor device

1. Treatment system for treating workpieces optionally for treating vehicle bodies, the treatment system comprising:
a plurality of fluid tanks which are fillable or filled with a treatment fluid and into which the workpieces can be introduced for carrying out a treatment process;
a conveying system for supplying the workpieces to the fluid tanks and/or for removing the workpieces from the fluid tanks; and
a fluid connection device for establishing a fluid connection between a plurality of the fluid tanks.

2. Treatment system according to claim 1, wherein a plurality of the fluid tanks is contained in self-contained individual containers for receiving the treatment fluid and in each case a single workpiece.

3. Treatment system according to claim 1, wherein a plurality of the fluid tanks is adjacent portions of a single container for receiving the treatment fluid, such that a single workpiece is to be received in each of the fluid tanks.

4. Treatment system according to claim 1, wherein the fluid connection device includes one or more overflow units which are connected to a plurality of the fluid tanks in each case and serve to receive treatment fluid which overflows from this fluid tank.

5. Treatment system according to claim 1, wherein the fluid connection device includes one or more flow devices optionally one or more pump devices and/or one or more nozzle devices, by which a treatment fluid can be supplied from one of the fluid tanks to another of the fluid tanks.

6. Treatment system according to claim 1, wherein the fluid tanks each include one or more mixing devices for mixing treatment fluid already present therein with supplied treatment fluid.

7. Treatment system according to claim 6, wherein one or more of the mixing devices each include one or more nozzle devices.

8. Treatment system according to claim 1, wherein the fluid connection device includes one or more pipe elements for establishing a fluid connection between two or more of the fluid tanks.

9. Treatment system according to claim 1, wherein a plurality of the fluid tanks adjoin one another directly, and in that side walls, facing one another, of the fluid tanks are formed by a common container wall or a common partition wall.

10. Treatment system according to claim 9, wherein the container wall or the partition wall includes one or more passage openings, so that a fluid connection is formed between the fluid tanks.

11. Treatment system according to claim 9, wherein the container wall or the partition wall is designed to be movable, optionally, liftable and/or lowerable—at least in portions.

12. Treatment system according to claim 1, wherein electrodes for generating an electrical field are arranged in two or more than two fluid tanks connected to one another by the fluid connection device, the electrical fields generated in the fluid tanks being decoupled from one another and/or shielded from one another.

13. Treatment system according to claim 1, wherein a common container wall of two containers which each form a fluid tank and/or treatment regions of a container which form a partition wall between two fluid tanks is to be electromagnetically shielding.

14. Treatment system according to claim 1, wherein a partition wall of the treatment system, the partition wall separating two treatment regions of a container, the two treatment regions forming two fluid tanks from one another
a) is designed as a grid or mesh; and/or
b) includes an additional support structure; and/or
c) receives one or more electrodes.

15. Treatment system according to claim 1, wherein a plurality of the fluid tanks is arranged next to one another in a horizontal direction, and/or wherein a plurality of the fluid tanks are arranged one above the other in a vertical direction.

16. Treatment system according to claim 1, wherein a plurality of fluid tanks are arranged offset relative to one another in the vertical direction, and wherein, by the fluid connection device, a fluid connection can be produced between these fluid tanks in such a way that treatment fluid of a fluid tank which is higher in a vertical direction flows automatically into a fluid tank which is lower in the vertical direction.

17. Treatment system according to claim 16, wherein the treatment system includes a preparation device for preparing the treatment fluid which is arranged in particular in a return path of the fluid connection device, the return path connecting the fluid tank which is lower in the vertical direction to the fluid tank which is higher in the vertical direction and serving to return the treatment fluid from the fluid tank which is lower in the vertical direction into the fluid tank which is higher in the vertical direction.

18. Treatment system according to claim 16, wherein the treatment system includes a sensor device by which a filling height of the fluid tank which is lower in the vertical direction can be determined and by which, when a predetermined maximum filling height is exceeded, a further supply of treatment fluid into this fluid tank can be stopped.

19. Treatment system according to claim 1, wherein the fluid tanks are exclusively dip tanks which are accessible from above, and/or wherein the treatment system is a dip coating system—optionally, a system for cathodic dip coating.

20. Method for treating workpieces—optionally vehicle bodies, the method comprising:
supplying treatment fluid to a plurality of fluid tanks of a treatment system, in particular, a treatment system according to claim 1—wherein the treatment fluid is fed successively to the plurality of fluid tanks and/or is circulated between the plurality of fluid tanks.
